(19) United States
(12) Patent Application Publication
(10) Pub. No.: US 2014/0105668 A1
(43) Pub. Date: Apr. 17, 2014

(54) Article and System for Dispensing Stick Butter, Margarine and Similar Articles

(71) Applicant: Dilek Cumrali, Paris (FR)

(72) Inventor: Dilek Cumrali, Paris (FR)

(21) Appl. No.: 13/650,236

(22) Filed: Oct. 12, 2012

(51) Int. Cl. B43K 1/00

(52) U.S. Cl. CPC A23P 1/00
USPC 401/292

(57) ABSTRACT

A butter holder, system for dispensing, and method of dispensing is provided where by an article formed of a unitary body that defines an interior central cavity, constructed and arranged with a configuration to accommodate a conventional stick of butter, said unitary body further formed of a pair of longitudinal opposing walls constructed and arranged to be elastically deformable, said body having opposing ends, a first open end and a second closed end and a removable lid dependent upon a living hinge, said hinge dependent on said unitary body.

### BACKGROUND OF THE INVENTION

Food preparers and culinary professionals alike are constantly in search of tools and implements in order to practice their craft. Of paramount importance to persons familiar with the art of food preparation becomes the use of the various senses of the body. This is not just limited to taste, but sight and touch are known to be equally important. There exist a number of articles that are provided for dispensing butter in food preparation. One of the biggest shortcomings in these articles relates to the fact that they use various arms, pistons and other remote devices to contact the butter and the food preparer does not get the tactile sense relating to the application of butter. The present invention addresses this need while providing a way of handling a stick of butter without contacting the hands and allowing the food preparer to utilize the sense of touch when applying the butter in food preparation.

### SUMMARY OF THE INVENTION

Although the present invention refers to a conventional stick of “butter,” the invention can be used with any article similarly configured including, but not limited to, margarine, shortening, and similar articles.

In one embodiment, sticks are 121 millimeters (4.8 in) long and 32 millimeters (1.3 in) wide, wherein the stick is generally a square solid.

Food preparers want to use sense of touch, but handling butter presents difficulties due to the surface properties.

The present invention provides an article and system, whereby a user accesses a holder in which butter is placed in an interior cavity. The user squeezes opposing walls in order to “grasp” the butter using the walls, while still being able to have a feel for the butter in the cavity.

The opposing walls are elastically deformable. As understood, the walls will bend inward toward one another upon application of pressure from a the exterior, and, upon release of the pressure, will return to their original orientation, that being substantially perpendicular to each respective end.

In one embodiment, the present invention is a butter holder and dispensing device comprising: a unitary body, wherein said unitary body defines an interior central cavity, said central cavity constructed and arranged with a configuration to accommodate a conventional stick of butter, said unitary body further formed of a pair of longitudinal opposing walls constructed and arranged to be elastically deformable, a first open end, and a second closed end; a removable lid dependent upon a living hinge, said hinge dependent on said unitary body.

In one embodiment, the two longitudinal walls are elastically deformable one to another at a distance of between 0.05 to 0.14 inches. In another embodiment, they are elastically deformable one to another at a distance of between 0.07 to 0.11 inches.

The two longitudinal that are elastically deformable one to another and are substantially perpendicular to said first end and a second end of said body in the absence of any inward pressure applied to said walls.

The present invention also encompasses a system for applying butter from a stick comprising:

a holder according to the present invention; and

a push tab constructed and arranged to position within said cavity and move a butter stick along said cavity, ultimately exiting an open end of said holder.

Further contemplated is a method of applying a stick of butter of other article in similar shape, said method comprising:

providing a holder according to the present invention; placing a stick in said interior cavity;

orienting said stick to be dispensed through said open end;

grasping each of said opposing walls such that said grasping deforms said walls inward, one to another, thus contacting the surface of said stick;

placing said open end on or near a surface in which dispensing of said stick is desired; dispensing said stick through said open end.

IN one embodiment, the method utilizes a push tab as described herein in order to push the stick out the open end.

### BRIEF DESCRIPTION OF THE SEVERAL VIEWS OF THE DRAWING

FIG. 1A is a perspective view of the open butter holder of the present invention with the end cap removed.

FIG. 1B is a perspective view of the butter holder of the present invention with the cover closed and the end cap in position.

FIG. 2 is an expanded view showing the component parts of the present invention.

FIG. 3 is an isometric view of the holder and lid with the lid in an open position.

FIG. 4 is an end view from FIG. 3.

FIG. 4A is a section view along section lines BB of FIG. 3.

FIG. 5 is a right side view of the butter holder from FIG. 3.

FIG. 6 is a top view of the end cap of the present invention.

FIG. 7 is an end view of the end cap of the present invention.

FIG. 8 is a side view of the end cap of the present invention.

FIG. 9 is a partial section view along section lines A-A of FIG. 6.

FIG. 10 is a front view of the manual pushing article associated with the present invention.

FIG. 11 is a side view of the manual butter pushing article from FIG. 10.

FIG. 12A depicts the butter holder in the environment of use with the end cap removed.

FIG. 12B is a side view showing the butter holder with the end cap in place.

FIG. 13 is a partial dimensional view of the holder in use.

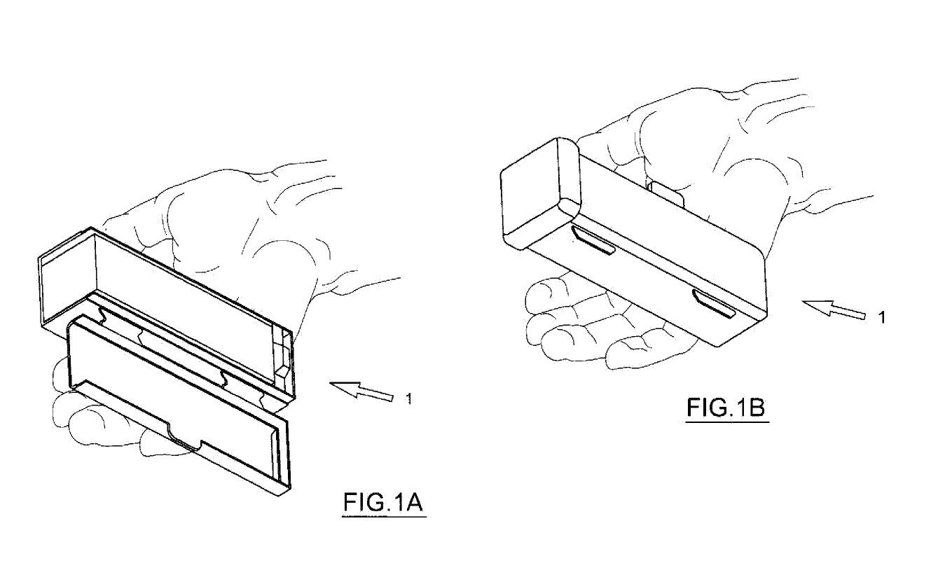

### DETAILED DESCRIPTION OF THE PREFERRED EMBODIMENT

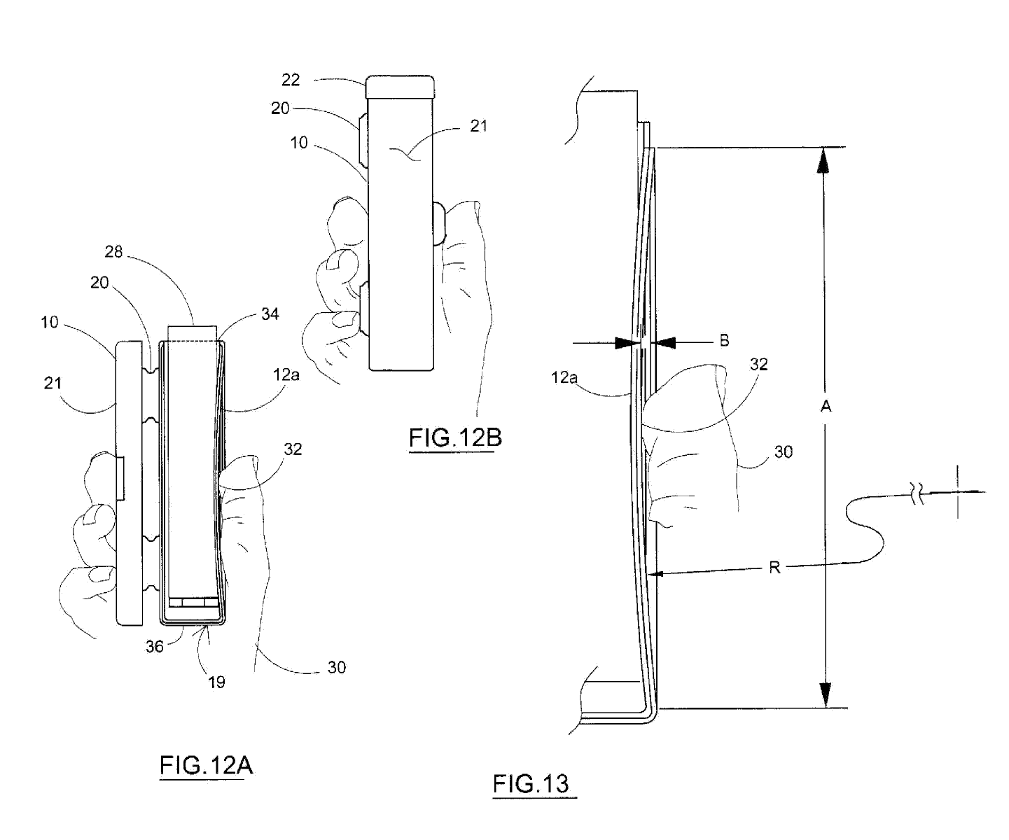

As described herein butter holder 1 is a unit whereby an inner cavity 23 is defined by a body 10 that is formed substantially to conform to the conventional size and shape of a stick of butter 28. Body 10 has a pair of opposing vertical sides 12a and 12b having on one side a living hinge 20 dependent thereon. Further dependent on living hinge 20 is a removable lid for accessing the inner cavity 23. Body 10 is constructed and arranged with a first end 34 and a second end 19 covered by fixed end cap 36. Said second end 19 encompasses a permanent closure, end cap 36 and said first end 34 is constructed and arranged to receive a removable cap 22 thereon. The butter holder encompasses a configuration whereby it is used with a manual butter dispensing tab 24. Said dispensing tab 24 has a plurality of holding points 26 disposed on one surface thereof. Holding points 26 are constructed and arranged such that they indent into the end surface of butter stick 28 and provide stabilization when push tab 24 is utilized. As generally understood in the environment of use a stick of butter 28 is placed within the inner cavity 23 of butter holder body 10. The butter can be stored in butter holder 10 by closing the lid in order to completely form a rectangular solid and cap 22 is affixed to first end 34. Cap end 22 affixes by interaction of snap protrusion 16 on body 10 that is complimentary with snap indentation 18 formed on cap 22. Persons familiar with culinary art understand that each of the five senses is important in food preparation. The present invention provides an improved holder for applying butter in food preparation. Other devices utilizing pistons and remote application means fail to take into account the desired attribute whereby one engaged in food preparation is able to use their sense of touch in applying butter. Each of the vertical walls of the present invention are elastically deformable. Elastically deformable only to the point that when a person applies pressure on either side such as shown in FIGS. 12A, 12B and 13 the walls move inward towards each other a certain length in order that the walls can contact butter 28 that is within the inner Cavity 23. As shown in FIG. 13 dimension A is the overall length of deflection of the walls 12 caused by pressure from hand 30 being applied to the walls of holder 1. Dimension B represents the deflection caused by pressure from the hand when applied at pressure point 32 along side the wall of butter holder 1. Dimension R is the radius caused by deflection at point 32. Dimension R is determined assuming a radius measure caused by the deflection placed on each of the walls of butter holder 1. The term elastically deformable as understood herein relates to one or both of the walls of body 10 constructed and arranged to move inward in the direction of each other such that a person can feel the pressure exerted on butter 28 held within holder 1. In doing so, a person can increase or decrease pressure in order to allow butter to be dispensed through first end 34 or to hold butter in place and inhibit dispensing. In one embodiment the distance of deflection of dimension B is between approximately 0.05 inches and 0.14 inches. In a preferred embodiment, the length of dimension B being the deflection is between approximately 0.07 inches and 0.11 inches.

The holder is formed of plastic, polymers, composites, or combinations thereof. It is constructed and arranged such that with repeated compression on side walls 12a and 12b, the walls return to a position wherein each wall 12 a and 12b is substantially parallel one to another and substantially perpendicular to end cap 36.

In one embodiment a first gradation 15 and a second gradation 14 provide visual indicators for dispensing common amounts. A common amount can vary, but can include a tablespoon measure, teaspoon measure, milliliter measure, and the like. In one embodiment, although only 2 gradations are illustrated, the present invention can have as many gradation markings as desired.

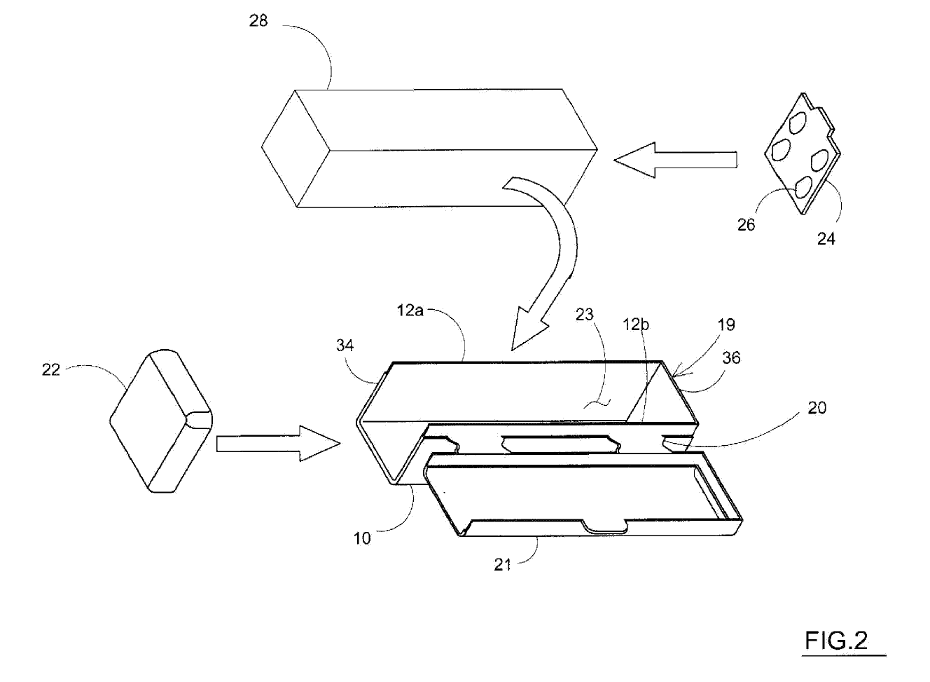

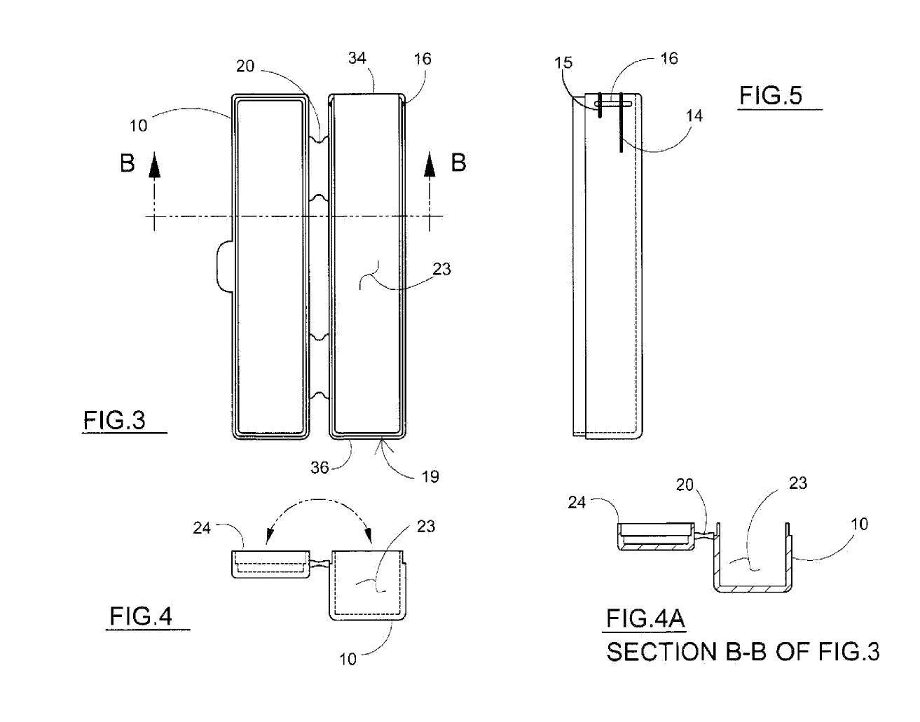

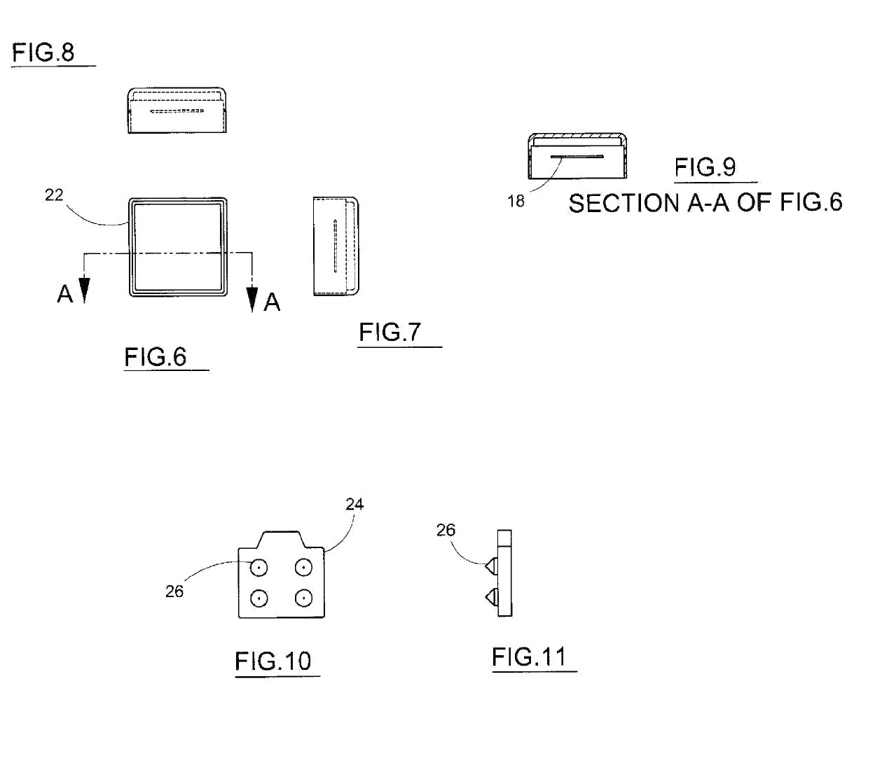

The present invention encompasses not only butter holder 1 but butter holder 1 constructed and arranged to be utilized with push tab 24 which is constructed and arranged with a plurality of holding points 26 on one side thereof. Push tab 24 is inserted at one end of butter stick 28, the end opposite first open end 34 and as shown in FIG. 2 directionally used to advance butter stick 28 through first open end 34. In this respect again, a user can apply varying pressure on each of opposing walls 12 of body 10 such that the user utilizes the sense of touch in dispensing butter 28. Utilizing the sense of touch is important because the food preparer can utilize both touch and sight to ensure a desired amount of butter is dispensed as desired.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A butter holder and dispensing device comprising:
a unitary body, wherein said unitary body defines an interior central cavity, said central cavity constructed and arranged with a configuration to accommodate a conventional stick of butter, said unitary body further formed of a pair of longitudinal opposing walls constructed and arranged to be elastically deformable, said body having opposing ends, a first open end and a second closed end;
a removable lid dependent upon a living hinge, said hinge dependent on said unitary body.

2. The holder of claim 1 wherein said holder comprises two longitudinal walls that are elastically deformable one to another at a distance of between 0.05 to 0.14 inches.

3. The holder of claim 1 wherein said holder comprises two longitudinal walls that are elastically deformable one to another at a distance of between 0.07 to 0.11 inches.

4. The holder of claim 1 wherein said holder comprises two longitudinal walls that are elastically deformable one to another and are substantially perpendicular to a first end and a second end of said body.

5. A system for applying butter from a stick comprising:
a holder according to claim 1; and
a push tab constructed and arranged to position within said cavity and move a butter stick along said cavity, ultimately exiting an open end of said holder.

6. A method of applying a stick of butter of other article in similar shape, said method comprising:
providing a holder according to claim 1;
placing a stick in said interior cavity;
orienting said stick to be dispensed through said open end;
grasping each of said opposing walls such that said grasping deforms said walls inward, one to another, thus contacting the surface of said stick;
placing said open end on or near a surface in which dispensing of said stick is desired;
dispensing said stick through said open end.
